(19) United States
(12) Patent Application Publication
(10) Pub. No.: US 2025/0196431 A1
(43) Pub. Date: Jun. 19, 2025

(54) PRODUCTION OF A COMPOSITE TIMEPIECE COMPONENT WITH WATERPROOF JOINT

(71) Applicant: The Swatch Group Research and Development Ltd, Marin (CH)

(72) Inventors: Marek DOVCIK, Mougins (FR); Nicolas FRANÇOIS, Neuchatel (CH); Sophie NAPOLI, Neuchatel (CH)

(73) Assignee: The Swatch Group Research and Development Ltd, Marin (CH)

(21) Appl. No.: 18/948,725

(22) Filed: Nov. 15, 2024

(30) Foreign Application Priority Data
Dec. 15, 2023 (EP) 23217069.6

(51) Int. Cl. B29C 64/10; B29L 31/00; B33Y 10/00; B33Y 70/00; B33Y 80/00

(52) U.S. Cl. CPC B29C 64/10; B33Y 10/00; B33Y 70/00; B33Y 80/00; B29L 2031/739

(57) ABSTRACT

A method for producing a composite timepiece component, wherein, in a first step, a base and a first material are provided; in a second step, the base is positioned on an additive manufacturing device; in a third step, a first raised portion made of the first material is grown by additive manufacturing on one side of the base; in a fourth step, the development of the first raised portion is verified, the third and fourth steps are repeated iteratively until the first raised portion is seen and verified to have developed beyond a setpoint value, and additive manufacturing is stopped when this development exceeds this setpoint value; optionally, a second raised portion made of a second material is grown by additive manufacturing on one side of the base and/or on the first raised portion.

### TECHNICAL FIELD OF THE INVENTION

The invention relates to a method for producing a composite timepiece component, and more particularly for producing a composite timepiece component with a waterproof joint.

The invention relates to the water-resistance of timepiece components and sub-assemblies.

### TECHNOLOGICAL BACKGROUND

Watertight seals are typically produced by injection moulding or extrusion, followed by machining or another manufacturing process requiring a machining step. These seals must meet very strict tolerance criteria.

In watchmaking, waterproof joints are present at all interfaces between the external environment and the interior of a timepiece, in particular of a watch. More particularly, but not exclusively, seals are found on the bearing surfaces of crystals, backs, crowns, push buttons, bolts, or other static or operating components, and more typically on all elements of a timepiece or watch that must be highly resistant to water.

The timepiece component and the waterproof joint with which this timepiece component must be in operational contact are manufactured independently.

Waterproof joints, particularly seals, are delicate to assemble and this operation is entrusted to qualified personnel and often requires a driving operation in order to assemble two non-watertight, rigid, timepiece components, with the risk of injuring this joint during this driving operation. A timepiece component can also be made integral with a waterproof joint by bonding or the like, but this does not provide good long-term stability, due to the difficulty of developing an adhesive that is suitable for both of the materials involved and stable over the operating temperature range.

### SUMMARY OF THE INVENTION

In order to avoid damaging the waterproof joints, as well as to avoid having to subject the timepiece component to machining operations that must be extremely precise in terms of dimensions and surface finish, the invention proposes producing bespoke waterproof joints, in particular seals, directly on timepiece components, and, in particular, proposes producing a bespoke seal manufactured, and in particular printed, on a timepiece component.

The purpose of the invention is to eliminate the need for certain driving and/or assembly steps by producing a joint, in particular a seal, directly on the component of a timepiece, in particular of a watch, so as to improve and guarantee water-resistance, as well as ensure the durability thereof.

Conventional waterproof joint production techniques involving moulding and/or turning limits the range of shapes that can be obtained, and typically involves producing a joint made of only one material.

The invention further proposes opening up a spectrum of special and unconventional seal shapes, by producing any shape of joint or seal, and doing so directly on the timepiece component.

The invention preferably uses an additive manufacturing process, in particular but not limited to 3D (i.e. three-dimensional) printing.

To this end, the invention relates to a method for producing a composite timepiece component.

According to the invention, in a first step, a base and at least one first material suitable for additive manufacturing are provided; in a second step, said base is prepared and positioned on an additive manufacturing means; in a third step, a first raised portion made of said at least one first material is grown by additive manufacturing on at least one side of said base; in a fourth step, the development of said first raised portion is verified against a first predetermined setpoint value, and said third step of additive manufacturing with the addition of said first material and said fourth step are repeated iteratively until said first raised portion is seen and verified to have developed to reach or exceed said first predetermined setpoint value, and additive manufacturing with the addition of said first material is stopped when said first raised portion has developed to reach or exceed said first predetermined setpoint value.

### BRIEF DESCRIPTION OF THE FIGURES

The purposes, advantages and features of the invention will be better understood upon reading the following detailed description given with reference to the accompanying drawings, in which:

FIG. 1 is a flow chart illustrating the various steps in the production of a composite timepiece component according to the invention, in the various alternative embodiments of this method;

FIG. 2 diagrammatically shows a sectional view of such a composite timepiece component produced using this method, with a first raised portion made of a first material being grown on a first side of a base;

FIG. 3 diagrammatically shows, similarly to FIG. 2, another composite timepiece component produced using this method, with a first raised portion made of a first material being grown on a first upper side of a base, and in another step, with another first raised portion made of the same first material being grown on a second lower side of the same base;

FIG. 4 diagrammatically shows, similarly to FIGS. 2 and 3, another composite timepiece component produced using this method, with a first raised portion made of a first material being grown on a first upper side of a base, with a second raised portion made of a second material being grown such that it is partially stacked on this first raised portion on the same first upper side, with and another second raised portion made of the same second material being grown on a second lower side of the same base.

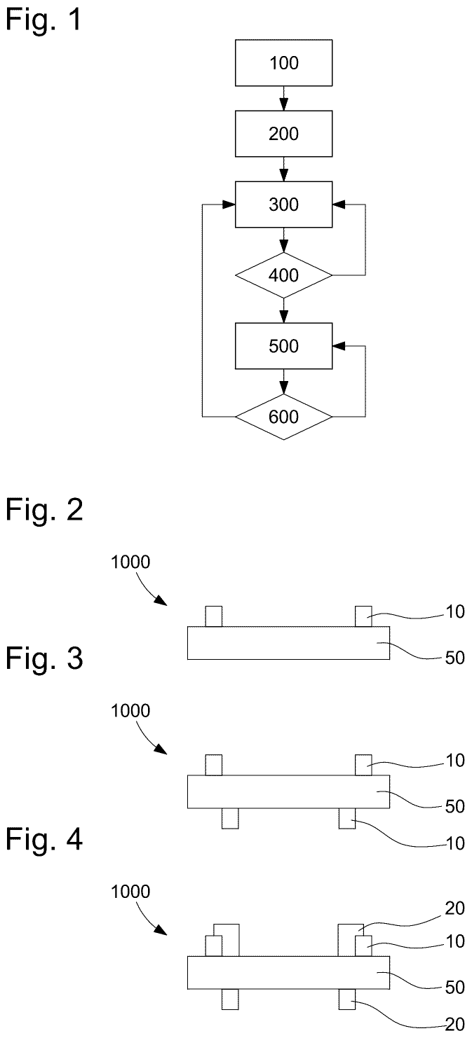

### DETAILED DESCRIPTION OF THE INVENTION

The invention relates to a method for producing a composite timepiece component 1000.

In a first step 100, a base 50 and at least one first material 1 suitable for additive manufacturing are provided.

In a second step 200, the base 50 is prepared and positioned on an additive manufacturing means.

In a third step 300, a first raised portion 10 made of at least one first material 1 is grown on at least one side of the base 50 by additive manufacturing.

In a fourth step 400, the development of the first raised portion 10 is verified against a first predetermined setpoint value.

Moreover the third step 300 of additive manufacturing with the addition of the first material 1 and the fourth step 400 are repeated iteratively until the first raised portion 10 is seen and verified to have developed to reach or exceed the first predetermined setpoint value, and additive manufacturing with the addition of the first material 1 is stopped when the first raised portion 10 has developed to reach or exceed the first predetermined setpoint value.

More particularly, in the first step 100 or in one of the subsequent steps, at least one second material 2 that is different from the first material 1 is provided and, during the third step 300 or during a fifth step 500 after the first raised portion 10 has developed to reach or exceed the first predetermined setpoint value, a second raised portion 20 made of the at least one second material 2 is grown by additive manufacturing on at least one side of the base 50 and/or on the first raised portion 10.

More particularly, in a first alternative embodiment, the second raised portion 20 is grown by additive manufacturing from the third step 300, and, in the fourth step 400 or in a sixth step 600, the development of the second raised portion 20 is verified against a predetermined second setpoint value, and a manufacturing step, which is the third step 300 of additive manufacturing with the addition of the second material 2 or a said fifth step 500 of additive manufacturing with the addition of the second material 2, on the one hand, and a verification step, which is the sixth step 600, on the other hand, are repeated iteratively until the second raised portion 20 is seen and verified to have developed to reach or exceed the predetermined second setpoint value, and additive manufacturing with the addition of the second material 2 is stopped when the second raised portion 20 has developed to reach or exceed the second predetermined setpoint value.

More particularly, in a second alternative embodiment, the second raised portion 20 is grown by additive manufacturing during such a fifth step 500 after the first raised portion 10 has developed to reach or exceed the first predetermined setpoint value. Moreover, in a sixth step 600, following the fifth step 500, the development of the second raised portion 20 is verified against a second predetermined setpoint value, and the fifth step 500 of additive manufacturing with the addition of the second material 2, and the sixth step 600, are repeated iteratively until the second raised portion 20 is seen and verified to have developed to reach or exceed the second predetermined setpoint value, and additive manufacturing with the addition of the second material 2 is stopped when the second raised portion 20 has developed to reach or exceed the second predetermined setpoint value.

More particularly still, the sixth step 600 is separate from the fourth step 400.

More particularly, in another alternative embodiment, in the third step 300 of additive manufacturing with the addition of the first material 1, the first raised portion 10 made of the at least one first material 1 is grown by additive manufacturing on at least two different sides of the base 50, in two separate steps, one on each side of the base 50.

More particularly, in another alternative embodiment, during the third step 300 or during a fifth step 500, a second raised portion 20 made of at least one second material 2 is grown by additive manufacturing on at least two different sides of the base 50, in two separate steps, one on each side of the base 50.

More particularly, in another alternative embodiment, during the third step 300 or during such a fifth step 500, a second raised portion 20 made of at least one second material 2 is grown by additive manufacturing on at least part of the first raised portion 10.

More particularly, the first material 1 is chosen to form a first raised portion 10 constituting a first waterproof joint.

More particularly, the second material 2 is chosen to form a second raised portion 20 constituting a second waterproof joint.

More particularly, the second material 2 is chosen to form a second raised portion 20 constituting a second waterproof joint with resistance properties complementary to those of the first waterproof joint.

More specifically, elastomer materials are chosen for the first material 1 and for the second material 2, which materials have different Shore hardnesses in the respective final state of the first raised portion 10 and of the second raised portion 20 after the additive manufacturing operations respectively adding the first material 1 and the second material 2.

More particularly, the material chosen for the first material 1 and for each at least one second material 2 is capable of forming a water-resistant layer after the additive manufacturing operations adding respectively the first material 1 and the at least one second material 2.

More particularly, the first raised portion 10 and the second raised portion 20 are produced with geometrically different developments compared to the base 50.

More particularly, the material chosen for at least the first material 1 is capable of forming a said first raised portion 10 optically contrasting the base 50, for a display function of the timepiece component 1000.

More particularly, the material chosen for at least the first material 1 is capable of forming a said first raised portion 10 that is fluorescent or phosphorescent.

More particularly, the material chosen for at least the first material 1 is capable of forming a said first raised portion 10 that is transparent and/or coloured.

More particularly, a transparent or translucent base 50 is chosen.

More particularly, a crystal, a back, a middle, a bezel or a crown is chosen as the base 50.

More particularly, said additive manufacturing is carried out by three-dimensional printing.

The invention is thus based on the production of a bespoke waterproof joint, in particular a seal, using additive manufacturing, in particular 3D printing directly onto a timepiece component, which guarantees manufacturing repeatability and control of production costs.

A person skilled in the art will also be able to apply this over-printed seal system to different types of timepiece components, such as crowns, driven in backs, middles, containers for capsule watches and the like.

3D printing can be carried out using an appropriate printer with a custom levelling option. Depending on the complexity of the component, the printer nozzle can be modified and adapted for optimum printing.

This method is advantageous in that no rejects are generated either during the manufacture of the waterproof joint or for the functional sub-assembly, which is the composite timepiece component produced by the method according to the invention, comprising a basic timepiece component and at least one joint permanently applied to this basic component. This method therefore does not result in the loss of material or in wasting operating time.

The invention allows for the production of difficult, complex joint shapes that would be impossible to achieve using any other technology.

The materials to be used in accordance with this technology include all thermoplastic materials, which covers a wide range of properties required in a waterproof joint.

A waterproof joint thus produced using additive processes, and in particular printing processes, can fulfil several functions: a sealing function, a display function and/or an aesthetic and/or decorative function, thanks to the wide range of possibilities in terms of colouring, transparency, shape, phosphorescence, fluorescence, as well as in terms of producing multi-material, multi-coloured or other types of waterproof joint.

1. A method for producing a composite timepiece component, wherein, in a first step, a base and at least one first material suitable for additive manufacturing are provided; in a second step, said base is prepared and positioned on an additive manufacturing means; in a third step, a first raised portion made of said at least one first material is grown by additive manufacturing on at least one side of said base; in a fourth step, the development of said first raised portion is verified against a first predetermined setpoint value, and said third step of additive manufacturing with the addition of said first material and said fourth step are repeated iteratively until said first raised portion is seen and verified to have developed to reach or exceed said first predetermined setpoint value, and additive manufacturing with the addition of said first material is stopped when said first raised portion has developed to reach or exceed said first predetermined setpoint value.

2. The production method according to claim 1, wherein, in said first step or in one of the subsequent steps, at least one second material that is different from said first material is provided, and in that wherein, during said third step or during a fifth step after said first raised portion has developed to reach or exceed said first predetermined setpoint value, a second raised portion made of said at least one second material is grown by additive manufacturing on at least one side of said base and/or on said first raised portion.

3. The production method according to claim 2, wherein said second raised portion is grown by additive manufacturing from said third step, and in that wherein, in said fourth step or in a sixth step, the development of said second raised portion is verified against a predetermined second setpoint value, and a manufacturing step, which is said third step of additive manufacturing with the addition of said second material or a said fifth step of additive manufacturing with the addition of said second material, on the one hand, and a verification step, which is said sixth step, on the other hand, are repeated iteratively until said second raised portion is seen and verified to have developed to reach or exceed said predetermined second setpoint value, and additive manufacturing with the addition of said second material is stopped when said second raised portion has developed to reach or exceed said second predetermined setpoint value.

4. The production method according to claim 2, wherein said second raised portion is grown by additive manufacturing during a said fifth step after said first raised portion has developed to reach or exceed said first predetermined setpoint value, wherein, in a sixth step, following said fifth step, the development of said second raised portion is verified against a second predetermined setpoint value, and said fifth step of additive manufacturing with the addition of said second material, and said sixth step, are repeated iteratively until said second raised portion is seen and verified to have developed to reach or exceed said second predetermined setpoint value, and additive manufacturing with the addition of said second material is stopped when said second raised portion has developed to reach or exceed said second predetermined setpoint value.

5. The production method according to claim 3, wherein said sixth step is separate from said fourth step.

6. The production method according to claim 1, wherein, in said third step of additive manufacturing with the addition of said first material, said first raised portion made of said at least one first material is grown by additive manufacturing on at least two different sides of said base, in two separate steps, one on each side of said base.

7. The production method according to claim 2, wherein, during said third step or during a said fifth step, a second raised portion made of said at least one second material is grown by additive manufacturing on at least two different sides of said base, in two separate steps, one on each side of said base.

8. The production method according to claim 2, wherein, during said third step or during a said fifth step, a second raised portion made of said at least one second material is grown by additive manufacturing on at least part of said first raised portion.

9. The production method according to claim 1, wherein said first material is chosen to form a said first raised portion constituting a first waterproof joint.

10. The production method according to claim 2, wherein said second material is chosen to form a said second raised portion constituting a second waterproof joint.

11. The production method according to claim 9, characterised in that wherein said second material is chosen to form a said second raised portion constituting said second waterproof joint with resistance properties complementary to those of said first waterproof joint.

12. The production method according to claim 2, wherein elastomer materials are chosen for said first material and for said second material, which materials have different Shore hardnesses in the respective final state of said first raised portion and of said second raised portion after the additive manufacturing operations respectively adding said first material and said second material.

13. The production method according to claim 2, wherein the material chosen for said first material and for each said at least one second material is capable of forming a water-resistant layer after the additive manufacturing operations adding respectively said first material and said at least one second material.

14. The production method according to claim 2, wherein said first raised portion and said second raised portion are produced with geometrically different developments compared to said base.

15. The production method according to claim 1, wherein the material chosen for at least said first material is capable of forming a said first raised portion optically contrasting said base, for a display function of said timepiece component.

16. The production method according to claim 1, wherein the material chosen for at least said first material is capable of forming a said first raised portion that is fluorescent or phosphorescent.

17. The production method according to claim 1, wherein the material chosen for at least said first material is capable of forming a said first raised portion that is transparent and/or coloured.

18. The production method according to claim 1, wherein a transparent or translucent base is chosen.

19. The production method according to claim 1, wherein a crystal, a back, a middle, a bezel or a crown is chosen as said base.

20. The production method according to claim 1, wherein said additive manufacturing is carried out by three-dimensional printing.

21. A timepiece comprising a timepiece component according to the method defined by claim 1.
